(19) United States
(12) Patent Application Publication
(10) Pub. No.: US 2009/0313688 A1
(43) Pub. Date: Dec. 17, 2009

(54) Method for Electronic Transaction by Mobile Messaging

(76) Inventor: Charles Tuil, Boulogne-Billancourt (FR)

Correspondence Address: IP GROUP OF DLA PIPER LLP (US), ONE LIBERTY PLACE, 1650 MARKET ST, SUITE 4900, PHILADELPHIA, PA, 19103, US

(21) Appl. No.: 11/794,530

(22) PCT Filed: Dec. 30, 2005
(86) PCT No.: PCT/FR05/03311

§ 371 Date: Aug. 9, 2007

(30) Foreign Application Priority Data
Dec. 31, 2004 (FR) 0453288

(51) Int. Cl. H04L 9/32; G06F 21/00

(52) U.S. Cl. 726/9

(57) ABSTRACT

A transactional process for a transaction with a user using an identification platform including (i) a registration stage including for the user, registering at the level of the platform, which registration includes at least supplying a telephone number of the user, and storing, at the level of the identification platform, at least one electronic token associated with the telephone number, as well as a transaction identifier associated with the transaction and with the electronic token; and (ii) a collection stage of the transaction including for the user, supplying a collection identifier to a collection terminal, and generating the transaction in the case of concordance between the collection identifier and the electronic token.

### RELATED APPLICATION

This is a §371 of International Application No. PCT/FR2005/003311, with an international filing date of Dec. 30, 2005 (WO 2006/072714 A1, published Jul. 13, 2006), which is based on French Patent Application No. 04/53288, filed Dec. 31, 2004.

### TECHNICAL FIELD

This disclosure relates to electronic transactions, more particularly, to an electronic transaction process using the telephone address of a user. This process is particularly useful for promotional offers.

### BACKGROUND

Current French regulations do not permit user addresses to be used for commercial purposes without the express agreement of the user. If the user agrees, it is, however, possible to make transactions of a promotional or commercial type using these addresses.

Moreover, it should be noted that along with the development of cell telephones in France and in the world the mobile telephone number of a user constitutes, as it were, a unique identifier.

The general problem posed by electronic transactions is, to be sure, the security of such transactions, as well as the precise identification of the persons that can benefit from the transaction. Numerous processes of the prior art have been proposed to guarantee this security. However, none of the known processes uses an identifier of the user constituted of all or part of the user's mobile telephone number for a secure transaction.

It could therefore be advantageous to address the problem of the security of electronic transactions by using a user identifier in the form of a mobile telephone number. This would be particularly simple and advantageous on account of the rapid development of mobile telephone communication techniques of the SMS or MMS type.

### SUMMARY

I provide a transactional process for a transaction with a user using an identification platform including (i) a registration stage including, for the user, registering at the level of the platform, which registration includes at least supplying a telephone number of the user and storing, at the level of the identification platform, at least one electronic token associated with the telephone number, as well as a transaction identifier associated with the transaction and with the electronic token; and (ii) a collection stage of the transaction including, for the user, supplying a collection identifier to a collection terminal and generating the transaction in the case of concordance between the collection identifier and the electronic token.

### BRIEF DESCRIPTION OF THE DRAWINGS

This disclosure will be better understood with the aid of the description, made below purely by way of explanation, of a representative example with reference made to the attached figures.

FIG. 1 is a functional scheme illustrating the transactional process according to a first aspect.

FIG. 2 is a functional scheme illustrating the transactional process according to a second aspect.

### DETAILED DESCRIPTION

I provide a transactional process for a transaction with a user making use of an identification platform comprising:

(i) a registration stage including:
for the user, registering (10) at the level of the platform, which registration comprises at least supplying the telephone number of the user, and
storing, at the level of the identification platform, at least one electronic token associated with the telephone number, as well as a transaction identifier associated with the transaction and with the electronic token; and

(ii) a collection stage of the transaction including:
for the user, supplying (70) a collection identifier to a collection terminal, and
generating (100) the transaction in the case of concordance between the collection identifier and the electronic token.

The registration stage advantageously comprises the sub-stages of:
reception by the user of a confirmation of registration from the platform;
sending a transaction identifier by the user; and
storage of the transaction identifier as a transaction identifier associated with the electronic token.

Furthermore, the registration stage preferably comprises a stage of sending the electronic token to the user and in which the collection stage comprises a search stage for the electronic token at the level of the identification platform, and a response stage of the electronic platform to the collection server as a function of the results of the search.

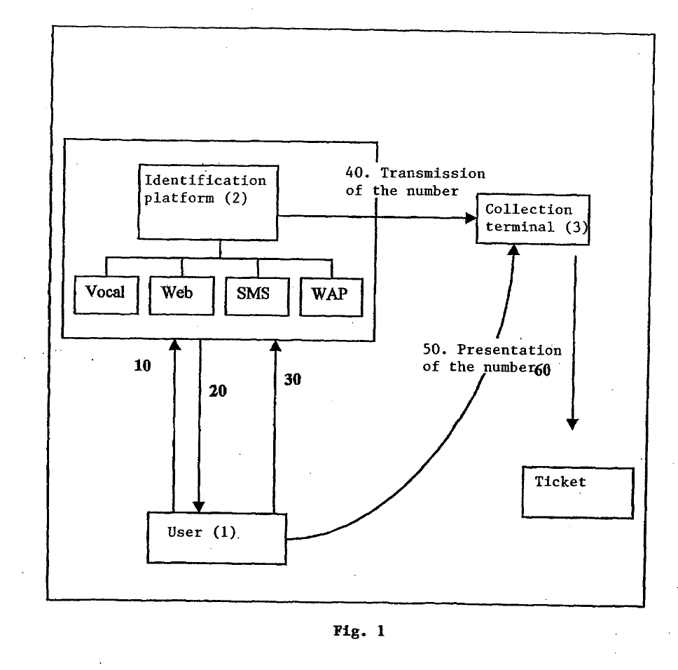

As illustrated in FIG. 1, a user 1 wishing to use the transaction service registers with an identification platform 2.

One skilled in the art will understand that the platform can comprise one or more servers constituting the stages of receipt and sending the different requests.

According to a first advantageous aspect, the registration is carried out by SMS or by any other telecommunication means. The platform actually corresponds to a specific call number. Thus, the client sends a message to the platform by SMS or by any other telecommunication means while indicating in a transmitted message at least the mobile telephone number and an acceptance of the offer of service. The acceptance can correspond, e.g., to the fact of accepting to receive a certain number of advertising messages or to accept that the number can be used to create use histories.

This stage corresponds to a registration 10 at the level of identification platform 2.

In response to that registration, the user receives a confirmation of the registration emitted by the identification platform on a mobile communication terminal (the number supplied during a first stage above).

The platform also returns the method of use of the service, preferably at the level of the user's terminal.

This stage is preferably carried out by an SMS mail to the user's mobile telephone, but confirmation may be sent by electronic mail or any communication system between the user and the registration server. The registered user is therefore entitled to use the service.

To benefit from the offers associated with this service, the user sends an identifier of an offer back to the platform during a selection stage of an offer 30. This mail is made, e.g., with SMS.

This offer identifier is preferably a simple code associated with the set of the locations using the service. The code may be a number between 1 and 999,999 and the SMS can be of the “SERVICE 225” type. It corresponds in fact to an identifier of the collection terminal situated at the location where the offer is applicable. The relationship between the identifiers of the collection terminals and their addresses is preferably stored in the identification platform.

The platform sends the telephone number of the user of the service, preferably at the level of the collection terminal, in a stage 40 and by virtue of the identifier of the collection terminal (e.g., its call number or an URL or any other telecommunication identifier).

When the user wishes to benefit from the offer, the user then presents a mobile telephone number to collection terminal 3. The terminal is preferably a terminal capable of rapidly carrying out searches in a number database. The terminal may be a Blackberry type. The user supplies, e.g., a number to a human operator who enters it or checks it in the Blackberry to search for it in the number database. If the number is not present in the Blackberry database, it is because it was not sent by the registration server and therefore the user is not entitled to benefit from the offer. If the number is present in the Blackberry database (which corresponds to a positive comparison between the number searched and a number of the number database) the user is entitled to benefit from the offer and receives, e.g., a ticket or an item associated with the offer. It is understood that the economic interest implemented by the technical process described above resides in the fact that the user of the service can benefit from offers of a promotional type.

It is understood that collection terminal 3 is not necessarily a Blackberry type terminal and that any terminal that can communicate remotely with the registration server can be used.

In particular, the terminal is automated and does not require the intervention of an operator. In this instance, the user can enter a telephone number at the level of a user interface of the terminal. The latter makes a comparison of the numbers and delivers or does not deliver a ticket or an item corresponding to the offer.

Finally, to avoid fraud consisting in supplying a telephone number that the user does not possess, the terminal can make a comparison after the receipt of an SMS. To this end, the terminal supplies a call number and, after receipt of the SMS, compares the sent number and the numbers in its number database. In the case of a positive comparison the ticket is delivered. A terminal in the form of an interactive terminal that permits its telephone number to be entered can also be used.

One skilled in the art will understand that the comparison of the telephone numbers is not necessarily made at the level of the collection terminal. In this case, the registration server itself retains the telephone numbers and the associated offers in its memory. When a user arrives at a collection terminal, the user supplies a telephone number and it is transmitted to the registration server with an identifier of the collection terminal so that it makes the comparison. In the case of a positive comparison, the authorization is then supplied by the registration server to the collection terminal that delivers the offer as previously. In this aspect, the confirmation of the search results therefore replaces stage 40 in FIG. 1.

One skilled in the art will also understand that comparisons made with the telephone numbers can correspond to modifications of pointers associated with the use number of a service. In this instance, if an offer gives access to two tickets with a reduction, the first use of the service will decrease the pointer by one unit.

Due to this type of pointer, a negative comparison can then correspond either to the absence of the telephone number in the number database or to the 0 value of the pointer associated with the number, signifying that this number no longer has the right to offers of this type.

Finally, one skilled in the art will understand that the process/system can be used at the level of an Internet site. In this instance, a specific interface permits the user to enter a mobile telephone number. Steps 10, 20 and 30 can then be realized by the Internet network and the telephone number of the user is used as an identifier. The delivery associated with the offer can even be delivered directly via the Internet.

Finally, to keep track of the behavior of the users of the service, it is possible to assign other identifiers to the user. These identifiers can be used as a client database.

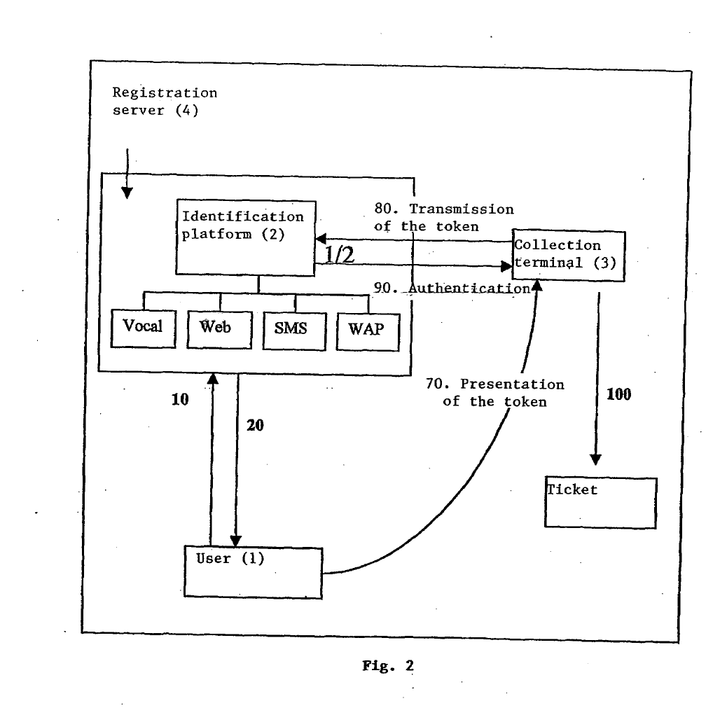

According to another aspect illustrated in FIG. 2, user 1 wishing to use the transaction service of the invention registers with transaction server 4 comprising, as previously, an identification platform 2.

This stage corresponds, as previously, to a registration 10 at the level of registration server 2.

In response to this registration, the user receives 20 a token associated with a mobile telephone number on a mobile communication terminal (the number supplied during a first stage above). This token is associated in a unique manner with the mobile telephone number of the user. It is presented, e.g., in the form of a code with a preferably one-to-one function of all or part of the mobile telephone number. The token may also be associated in a unique manner with a particular transaction that the user requested during registration stage 10.

Registration server 4 registers the correspondences between the tokens supplied to the users, the telephone numbers of the users, and the transactions associated with the supplied tokens in a database.

The registration server also returns an agreement of pre-registration and the method for using the electronic token preferably to the level of the user's terminal.

Finally, it is also possible for the token to be sent by electronic mail or any communication system between the user and the registration server. The user provided with the token obtained during the registration stage is thus entitled to use the service.

When the user wishes to benefit from the offer, the user then presents 70 the electronic token to collection terminal 3. In request stage 80, collection terminal 3 interrogates the registration server to know whether the user who just presented a token is identified and, if so identified, which transaction is the one associated with the token. If the token corresponds well to a person registered at the level of the registration server, a transaction identifier associated with the token is then returned 90 to collection terminal 3. Stage 90 corresponds to the identification of the user's token. In the case of authentication, the collections server then delivers 100 the transaction to the user, e.g., in the form of a ticket.

It is understood that if the identifier supplied by the user at the level of collection terminal 3 during the presentation stage of the token 70 is erroneous and does not correspond to any user registered at the level of registration server 4, the transaction is then refused. This can be notified to the user in the form of a message.

This disclosure was described by way of example. It is understood that one skilled in the art is capable of realizing different variations without departing from the scope of the disclosure as defined in the appended claims.

1-3. (canceled)

4. A transactional process for a transaction with a user using an identification platform comprising:
(i) a registration stage comprising:
for the user, registering at the level of the platform, which registration comprises at least supplying a telephone number of the user, and
storing, at the level of the identification platform, at least one electronic token associated with the telephone number, as well as a transaction identifier associated with the transaction and with the electronic token; and
(ii) a collection stage of the transaction comprising:
for the user, supplying a collection identifier to a collection terminal, and
generating the transaction in the case of concordance between the collection identifier and the electronic token.

5. The process according to claim 4, wherein the registration stage comprises the sub-stages of:
reception by the user of a confirmation of registration from the platform;
sending a transaction identifier by the user; and
storage of the transaction identifier as a transaction identifier associated with the electronic token.

6. The process according to claim 4, wherein the registration stage further comprises a stage of sending the electronic token to the user and in which the collection stage comprises a search stage for the electronic token at the level of the identification platform, and a response stage of the electronic platform to the collection server as a function of the results of the search.
